(19) United States
(12) Patent Application Publication
(10) Pub. No.: US 2026/0287557 A1
(43) Pub. Date: Sep. 24, 2026

(54) ULTRASONIC PROBE, PNEUMATICALLY DRIVEN LIQUID METERING INJECTION APPARATUS, AND CONTROL AND FAULT-DIAGNOSIS METHOD FOR PNEUMATICALLY DRIVEN LIQUID METERING INJECTION BASED ON ULTRASONIC SENSING

(71) Applicant: SHENZHEN KEWEI NEO_TECH CO., LTD., SHENZHEN CITY (CN)

(72) Inventor: LIQUN YU, WUHAN CITY (CN)

(21) Appl. No.: 19/570,250

(22) Filed: Mar. 18, 2026

(30) Foreign Application Priority Data
Mar. 18, 2025 (CN) 202510324154.4

(51) Int. Cl. G01N 29/22; F01N 3/20; G01N 29/024

(52) U.S. Cl. CPC G01N 29/222; G01N 29/024; F01N 3/208; F01N 2610/02; F01N 2610/1406; F01N 2610/146; G01N 2291/0222; G01N 2291/02809; G01N 2291/02836; G01N 2291/02872; G01N 2291/02881

(57) ABSTRACT

An ultrasonic probe, a pneumatically driven liquid metering injection apparatus, and a control and fault-diagnosis method for pneumatically driven liquid metering injection based on ultrasonic sensing. In the pneumatically driven liquid metering injection apparatus, a storage tank is configured to accommodate a liquid to be injected and the ultrasonic probe, receive an airflow from a gas source, and discharge the accommodated liquid to an exterior through an outlet pipeline. The control and fault-diagnosis method based on the ultrasonic sensing includes: calibrating parameters measured by the ultrasonic probe; calibrating injected liquid state parameters; identifying an injected-liquid state; and, in response to the identified state, adjusting a control strategy.

### FIELD OF THE DISCLOSURE

The present application relates to the field of exhaust aftertreatment for diesel vehicles, and in particular to an ultrasonic probe, a pneumatically driven liquid metering injection apparatus, and a control and fault-diagnosis method for pneumatically driven liquid metering injection based on ultrasonic sensing.

### BACKGROUND OF THE DISCLOSURE

In China, diesel engines commonly adopt the selective catalytic reduction (SCR) route to meet emission standards. A urea-water solution is injected into exhaust gas; ammonia (NH₃) generated by thermal decomposition of urea reduces NOx on a catalyst to nitrogen (N₂) and water (H₂O).

The design approach for early SCR systems in terms of urea supply and injection systems stemmed from a linear mindset, i.e., given that the atomization for chemical reaction requires fine urea solution droplets, then high-pressure swirl or micro-orifice injection is provided to form mist; given that high liquid pressure is needed, then a liquid pressurizing pump is provided. Since the implementation of Euro III/China IV, field feedback shows that pump-based urea supply/injection systems frequently fail under harsh exhaust and vehicle operating environments, compounded by urea crystallization and freezing at low temperatures. Failures include pump mechanisms in the injection line and clogging of metering valve orifices, with many modes and persistently high rates; for some suppliers, failures exceed 10,000 PPM per million operating hours, which has hindered adoption.

Referring to Chinese Patent Applications CN20101051391.0, CN201020661310.5, and CN20101051392.5, a China FAW Group proposed a novel pneumatic route centered on a single urea tank. During vehicle operation, tank pressure from a gas source drives urea flow in the injection line or establishes pre-injection liquid pressure; once the control system detects liquid pressure sufficient for atomization, metering injection is executed. After engine shutdown, the gas source purges residual urea from the line to avoid crystallization or freeze-induced blockage in winter. A single gas source is used for both injection and purging, implemented via separate gas lines and on/off solenoid valves. To meet control needs, independent pressure sensors are arranged at corresponding nodes or spaces in the gas lines to acquire control signals. This approach addresses the long-standing issues of pump-pressurized urea injection.

Chinese Patent Application CN201710049760.5 discloses a pneumatic urea injection system with dual pressure sensors, which aims to optimize the ECU, and diagnose the states of the liquid filter and metering valve based on gas and liquid pressures. In particular, for liquid-pressure acquisition, a complex and costly arrangement is designed: the liquid-pressure sensor includes a control chip, a sensor connector, a heat-conducting plate, and an electrically heated urea tube.

The pneumatic urea supply and metering injection, as compared to pump-pressurized metering injection, represents an innovative advancement. However, it still follows conventional, widely used approaches guided by linear mindset—e.g., reed switches for level, stress-sensitive chips for pressure—leaving room for improvement in cost control and intelligent system diagnostics.

### SUMMARY OF THE DISCLOSURE

To overcome deficiencies in existing pneumatic urea supply and metering injection technologies, the present application provides an ultrasonic probe, a pneumatically driven liquid metering injection apparatus, and a control and fault-diagnosis method for pneumatically driven liquid metering injection based on ultrasonic sensing. The solution achieves, in a highly integrated manner, high-precision measurement of liquid temperature, concentration, liquid-level height, and tank gas pressure, identifies abnormal operating conditions of the pneumatic metering injection apparatus, and improves NOx management.

### First Aspect

An ultrasonic probe disposed inside a liquid storage container and configured to measure liquid temperature, concentration, liquid-level height, and storage gas pressure, includes:
a sensing chamber for receiving a liquid under test;
a reservoir channel in communication with the sensing chamber with an internal accommodation space of the liquid storage container;
a temperature sensor disposed in the sensing chamber to measure the liquid temperature;
a first ultrasonic reflection module disposed on a first rigid sidewall of the sensing chamber;
a first ultrasonic sensing module disposed on a second rigid sidewall, and configured to transmit an ultrasonic detection signal to the first ultrasonic reflection module, receive a reflected signal, and obtain a first time-of-flight (TOF) indicative of the liquid concentration;
a second ultrasonic reflection module disposed on an elastic sidewall of the sensing chamber; a first gas chamber is provided outside the elastic sidewall and is in communication with gas inside the liquid storage container; the elastic sidewall is configured to deform according to a difference between a liquid pressure at its position in the sensing chamber and a gas pressure within the liquid storage container;
a second ultrasonic sensing module disposed on a third rigid sidewall, configured to transmit an ultrasonic detection signal to the second reflection module, receive a reflected signal, and obtain a second TOF indicative of the liquid-level height;
a third ultrasonic reflection module disposed on an elastic top surface of the sensing chamber; a second gas chamber is provided above the elastic top surface and is in communication with ambient atmosphere outside the liquid storage container; the elastic top surface is configured to deform according to a difference between a liquid pressure at its location in the sensing chamber and ambient atmospheric pressure; and
a third ultrasonic sensing module disposed on a bottom surface of the sensing chamber, configured to transmit an ultrasonic detection signal to the third reflection module, receive a reflected signal, and obtain a third TOF indicative of an internal gas pressure of the liquid storage container.

In some embodiments, the ultrasonic probe includes a body, a side cover, and a top cover, with the sensing chamber being arranged in the body. The elastic sidewall of the sensing chamber has a first elastic diaphragm arranged between the body and the side cover, and the first gas chamber is defined between the first diaphragm and the side cover. The elastic top surface of the sensing chamber has a second elastic diaphragm arranged between the body and the top cover, and the second gas chamber is defined between the second diaphragm and the top cover.

In some embodiments, a sidewall clamp ring and a sidewall retainer cup are provided between the body and the side cover to clamp and fix an outer edge of the first diaphragm. The retainer cup has a sidewall vent hole; the side cover has a sidewall gas passage with a lateral port facing the vent hole; and the top cover has an in-tank gas communication passage. The sidewall vent hole, the sidewall gas passage, and the in-tank gas communication passage intercommunicate, and the in-tank gas communication passage is in communication with the gas inside the liquid storage container via a pipeline.

In some embodiments, a top-surface clamp ring and a top-surface retainer cup are provided between the body and the top cover to clamp and fix an outer edge of the second diaphragm. The top-surface retainer cup has a top-surface vent hole, and the top cover has a top-surface gas passage. The top-surface vent hole and the top-surface gas passage intercommunicate, and the top-surface gas passage is in communication with ambient atmosphere outside the liquid storage container via a pipeline.

In some embodiments, each of the first ultrasonic reflection module, the second ultrasonic reflection module, and the third ultrasonic reflection module is made of stainless steel and is provided with a planar reflective surface.

In some embodiments, an outer periphery of the first elastic diaphragm is formed as a bellows, with the first ultrasonic reflection module at its center; and an outer periphery of the second elastic diaphragm is formed as a bellows, with the second ultrasonic reflection module at its center.

In some embodiments, the first ultrasonic reflection module is welded to the first elastic diaphragm, and the second ultrasonic reflection module is welded to the second elastic diaphragm.

In some embodiments, a spring is arranged in the top-surface retainer cup and is abutted against a back side of the second elastic diaphragm.

In some embodiments, the reservoir channel passes through the ultrasonic probe, with an inlet orifice at a bottom of the ultrasonic probe and an outlet orifice at a top of the ultrasonic probe.

In some embodiments, an electrical unit is provided at the bottom of the ultrasonic probe and is correspondingly and electrically connected to the temperature sensor, the first ultrasonic sensing module, the second ultrasonic sensing module, and the third ultrasonic sensing module. A first wire-harness passage is provided on a side of the body, and a second wire-harness passage is provided on the top cover. A wire harness of the electrical unit passes through the first wire-harness passage and the second wire-harness passage, and is led out of the liquid storage container via a conduit.

### Second Aspect

A pneumatically driven liquid metering injection apparatus includes the ultrasonic probe above, and further includes:
a gas source configured to provide a driving airflow for liquid injection;
a storage tank configured to accommodate a liquid to be injected and the ultrasonic probe. the storage tank is connected to the gas source via an intake pipeline to receive airflow from the gas source, and is configured to discharge the accommodated liquid via an outlet pipeline; and
a control module configured to control gas supply from the gas source to the storage tank and to control injection of the liquid from the storage tank.

In some embodiments, the storage tank has a tank body and an end cap that are sealed together. An in-tank gas communication pipeline in communication with the first gas chamber of the ultrasonic probe, and an ambient-air communication pipeline in communication with the second gas chamber of the ultrasonic probe is provided inside the storage tank. The intake pipeline, the outlet pipeline, and the ambient-air pipeline all penetrate the end cap.

In some embodiments, a top end of the in-tank gas communication pipeline is fixed to an inner side of the end cap, the inner side is provided with an airflow channel, through which the pipeline communicates with tank gas.

In some embodiments, a bottom terminal end of the outlet pipeline is plug-fitted into the reservoir channel of the ultrasonic probe.

In some embodiments, an antifreeze pipeline is further arranged in the storage tank and penetrates the end cap.

In some embodiments, the storage tank has a fill port.

In some embodiments, the intake pipeline is provided with an intake valve, and the storage tank further includes an exhaust pipeline with a vent valve; the control module is connected to and controls the intake valve and the vent valve.

In some embodiments, the intake pipeline is further connected to the outlet pipeline via a purge pipeline, the purge pipeline is provided with a purge valve; and the control module is connected to and controls the purge valve.

In some embodiments, the control module includes:
a vehicle operating-state acquisition unit configured to acquire a vehicle operating state;
a gas-supply control unit configured to control gas supply from the gas source to the storage tank;
an injection-valve control unit configured to send control commands to an injection valve based on the vehicle operating state;
an injected-liquid state acquisition unit configured to acquire the temperature, the first TOF, the second TOF, and the third TOF detected by the ultrasonic probe and, based on prior calibration data, determine the temperature, the concentration, the liquid-level height, and the storage gas pressure by data lookup or curve-fitting; and
a strategy and diagnosis unit configured to send control commands to a gas supply and the injection valve according to the vehicle operating state, determine an operating state of the pneumatically driven liquid metering injection apparatus based on real-time probe data, identify abnormal operating conditions, and adjust the control commands for the gas supply and the injection valve to obtain improved NOx management.

### Third Aspect

A control and fault-diagnosis method for pneumatically driven liquid metering injection based on ultrasonic sensing includes:
calibrating ultrasonic-probe measurement parameters: under different liquid temperatures, concentrations, liquid-level heights, and storage gas pressures, obtaining data of liquid temperature, first TOF, second TOF, and third TOF detected by an ultrasonic probe, and calibrating values of liquid concentration, liquid-level height, and storage gas pressure;
calibrating injected-liquid state parameters: under respective vehicle operating states, controlling injection by an injection valve to obtain, for no-clogging/no-leakage and various degrees of clogging or leakage, a rate of change of liquid-level height and statistical values related to fluctuations of the third TOF; establishing correspondences between clogging/leakage states and the rate of change and said statistical values;
identifying an injected-liquid state: acquiring the vehicle operating state, obtaining liquid temperature, first TOF, second TOF, and third TOF via the probe, computing the rate of change of liquid-level height and the statistical values related to third-TOF fluctuations, and identifying a clogging or leakage state of the injection valve; and
adjusting a control strategy based on the injected-liquid state: adjusting a current injection-valve control strategy according to the vehicle operating state and the identified clogging or leakage state of the injection valve to obtain improved NOx management.

### Beneficial Effects

With the foregoing, the ultrasonic probe of the present application performs, in a highly integrated manner, high-precision measurement of liquid temperature, concentration, liquid-level height, and storage gas pressure, delivering both very high accuracy and low cost. Because the ultrasonic probe is arranged inside the storage tank, the pneumatic metering injection apparatus integrates both control of urea injection and state monitoring during injection in a compact structure. Based on real-time monitoring of the injection state, the method adjusts injection control strategy and improves NOx management.

### BRIEF DESCRIPTION OF THE DRAWINGS

To more clearly illustrate the technical solutions in the embodiments of the present disclosure or in the prior art, the following is a brief introduction to the drawings required in the description of the embodiments or prior art. It is evident that the drawings described below are merely embodiments of the present disclosure, and those skilled in the art may derive other drawings based on the provided figures without any creative effort.

FIG. 1 is a schematic view of a pneumatically driven liquid metering injection apparatus according to some embodiments.

FIG. 2 is a schematic view of a storage tank and an internal ultrasonic probe according to some embodiments.

FIG. 3 is a schematic sectional view taken along line A-A of FIG. 2.

FIG. 4 is an enlarged view of part C of FIG. 3.

FIG. 5 is an enlarged view of part D of FIG. 3.

FIG. 6 is a schematic sectional view taken along line B-B of FIG. 2.

FIG. 7 is an enlarged view of part E of FIG. 6.

FIG. 8 is an enlarged view of part F of FIG. 6.

FIG. 9 is a schematic view of an ultrasonic probe according to some embodiments.

FIG. 10 is a schematic sectional view taken along line G-G of FIG. 9.

FIG. 11 is a schematic sectional view taken along line H-H of FIG. 9.

FIG. 12 is a schematic sectional view taken along line J-J of FIG. 9.

FIG. 13 is a schematic exploded view of the ultrasonic probe according to some embodiments.

FIG. 14 is a schematic sectional view of the ultrasonic probe according to some embodiments.

FIG. 15 is a schematic view of a control module of the pneumatically driven liquid metering injection apparatus according to some embodiments.

FIG. 16 is a flowchart showing a control and fault-diagnosis method for pneumatically driven liquid metering injection based on ultrasonic sensing according to some embodiments.

### REFERENCE NUMERALS

100—gas source; 200—storage tank; 210—intake pipeline; 211—intake valve; 212—purge pipeline; 2121—purge valve; 220—outlet pipeline; 230—in-tank gas communication pipeline; 240—ambient-air communication pipeline; 250—tank body; 260—end cap; 261—airflow channel; 270—antifreeze pipeline; 280—wire-harness conduit; 290—exhaust pipeline; 291—vent valve; 2100—fill port; 300—ultrasonic probe; 310—sensing chamber; 311—temperature sensor; 312—first ultrasonic sensing module; 313—first ultrasonic reflection module; 314—second ultrasonic sensing module; 315—second ultrasonic reflection module; 316—third ultrasonic sensing module; 317—third ultrasonic reflection module; 320—first gas chamber; 330—second gas chamber; 340—body; 341—wire-harness passage; 350—side cover; 351—sidewall clamp ring; 352—sidewall retainer cup; 3521—sidewall vent hole; 353—sidewall gas passage; 360—top cover; 361—in-tank gas communication passage; 362—top-surface clamp ring; 363—top-surface retainer cup; 3631—top-surface vent hole; 364—top-surface gas passage; 370—first elastic diaphragm; 380—second elastic diaphragm; 390—reservoir channel; 391—inlet orifice; 392—outlet orifice; 3100—electrical unit; 400—control module; 500—injection valve.

### DETAILED DESCRIPTION OF THE EXEMPLARY EMBODIMENTS

The following description in conjunction with the accompanying drawings further illustrates the application.

The embodiments explain rather than limit the scope. Modifications or equivalent substitutions that do not depart from the spirit and scope of the claims fall within the protection scope.

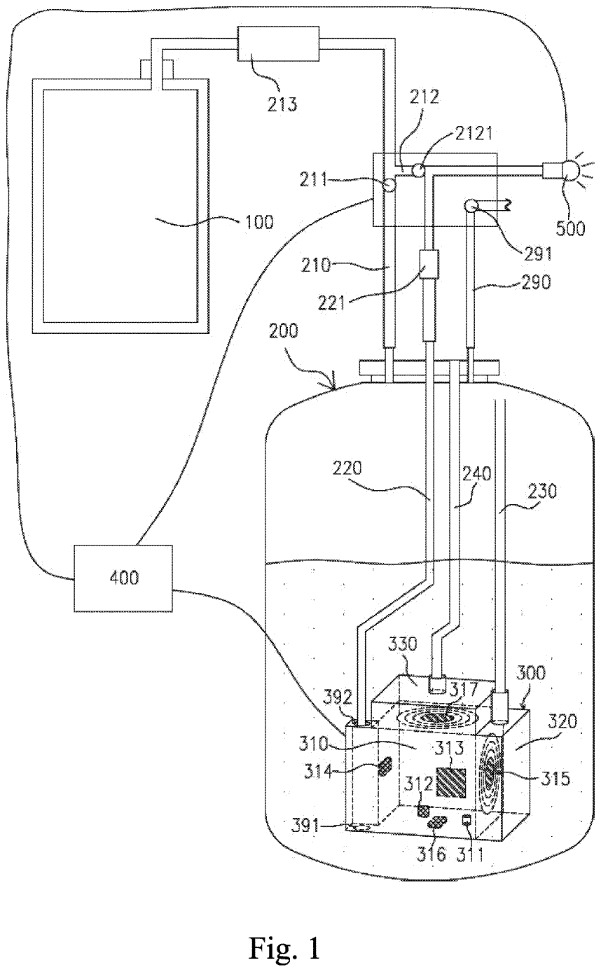

Referring to FIG. 1, an ultrasonic probe 300 provided by the present application is disposed inside a liquid storage container to measure liquid temperature, concentration, liquid-level height, and storage gas pressure. The ultrasonic probe 300 includes a sensing chamber 310 and a reservoir channel 390. The liquid storage container can be a storage tank 200.

The sensing chamber 310 receives a liquid under test and is bounded by first, second, and third rigid sidewalls, an elastic sidewall, a bottom surface, and an elastic top surface. The sensing chamber 310 communicates with an internal accommodation space of the liquid storage container via the reservoir channel 390.

A temperature sensor 311 is disposed in the sensing chamber 310 and configured to measure liquid temperature T. In some implementations, the temperature sensor 311 is a PTC or NTC element.

A first ultrasonic reflection module 313 is disposed on the first rigid sidewall of the sensing chamber 310, and a first ultrasonic sensing module 312 is disposed on the second rigid sidewall. The first ultrasonic sensing module 312 is configured to transmits a first ultrasonic sensing signal to the first ultrasonic reflection module 313 through the liquid, receive a reflected signal from the first ultrasonic reflection module 313, and acquire a first time-of-flight (TOF) t₁ representing a round-trip between the first ultrasonic sensing module 312 and the first ultrasonic reflection module 313. Since the first flight velocity V₁ depends on both the liquid concentration C of the liquid under test and the liquid temperature T, the concentration C can be determined by measuring the first TOF t₁ with the liquid temperature T known. For example, a calibration can be used establish a mapping C_{Tx}(t₁) of liquid concentration relative to the first TOF t₁ at different liquid temperatures T_{X}. The concentration C can then be calculated through numerical interpolation or curve fitting based on the measured liquid temperature T and the TOF t₁.

A second ultrasonic reflection module 315 is disposed on the elastic sidewall of the sensing chamber 310, and a second ultrasonic sensing module 314 is disposed on the third rigid sidewall opposing to the elastic sidewall. A first gas chamber 320 is provided outside the elastic sidewall and communicates with a gas in the liquid storage container. The elastic sidewall is configured to deform according to a difference between the local liquid pressure in the sensing chamber 310 and a gas pressure within the liquid storage container.

The second ultrasonic sensing module 314 is configured to transmit a second ultrasonic sensing signal to the second ultrasonic reflection module 315, receive a reflected signal from the second ultrasonic reflection module 315, and acquire a second TOF t₂ representing a round-trip between the second ultrasonic sensing module 314 and the second ultrasonic reflection module 315. The second flight velocity of the transmitted ultrasonic wave in the liquid is V₂=D₂/t₂. D₂ represents a second flight distance, which equals twice a distance between the second ultrasonic sensing module 314 and the second ultrasonic reflection module 315. This distance is twice a sum of the original gap d between the second ultrasonic sensing module 314 and the second ultrasonic reflection module 315 in the detection cavity 310 (when empty of liquid) and an outward expansion distance dx of the elastic sidewall caused by liquid pressure.

A third ultrasonic sensing module 316 is disposed on the bottom surface of the sensing chamber 310, and a third ultrasonic reflection module 317 is disposed on the elastic top surface of the sensing chamber 310. A second gas chamber 330 is provided above the elastic top surface and is open to ambient atmosphere. The elastic top surface is configured to deform according to a difference between the local hydrostatic pressure within the sensing chamber 310 and ambient pressure.

The third ultrasonic sensing module 316 is configured to transmit a third ultrasonic sensing signal to the third ultrasonic reflection module 317, receive a reflected signal from the third ultrasonic reflection module 317, and acquire a third TOF t₃ representing a round-trip between the third ultrasonic sensing module 316 and the third ultrasonic reflection module 317.

In some implementations, the first ultrasonic sensing module 312, the second ultrasonic sensing module 314, and the third ultrasonic sensing module 316 each include a piezoelectric ceramic that is configured to transmit/receive ultrasonic signals, converting between electrical signals and ultrasound. The first ultrasonic sensing module 312, the second ultrasonic sensing module 314, and the third ultrasonic sensing module 316 each are mounted on an insulating component.

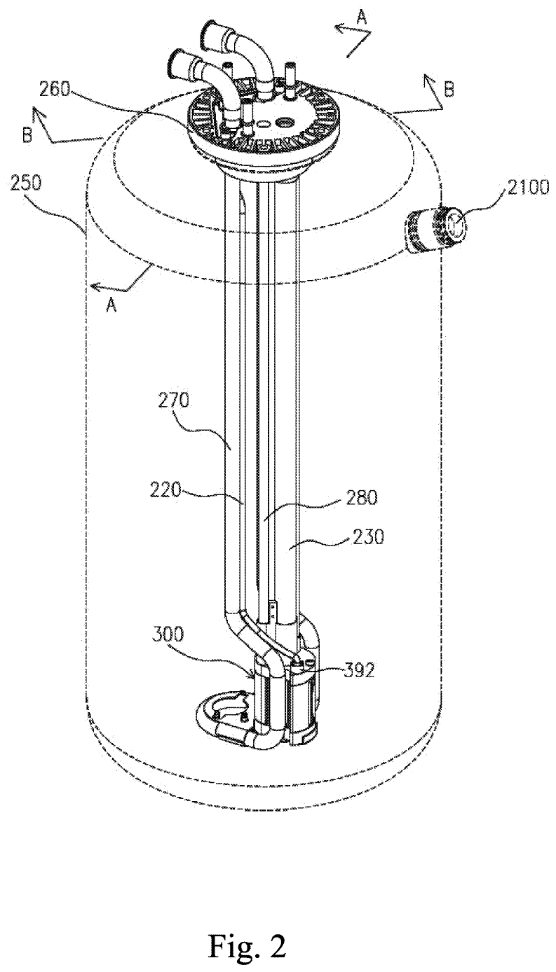

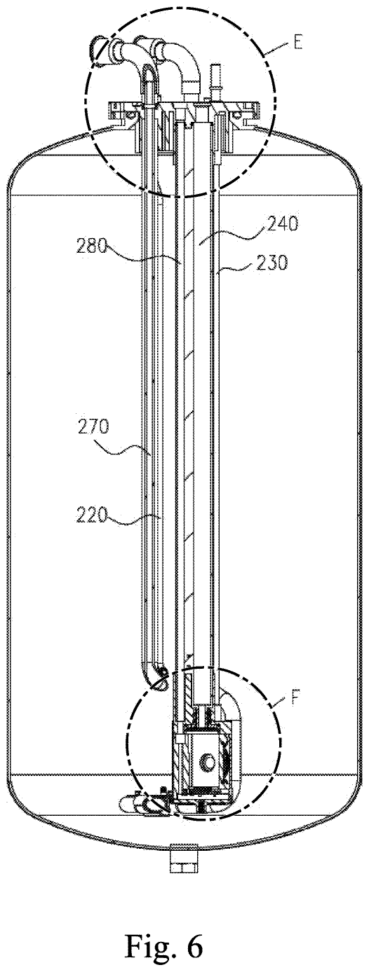

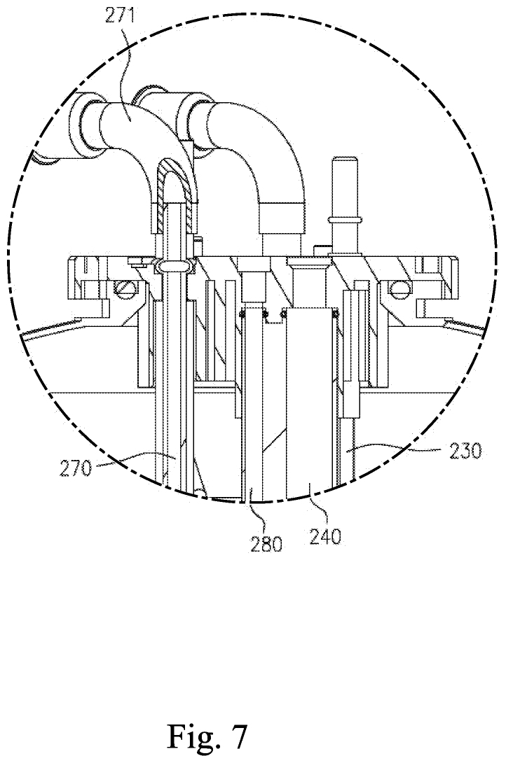

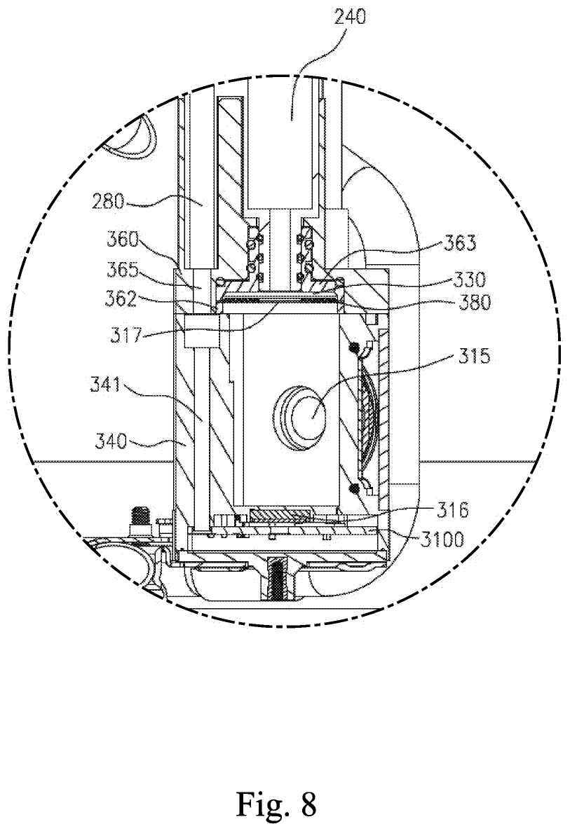

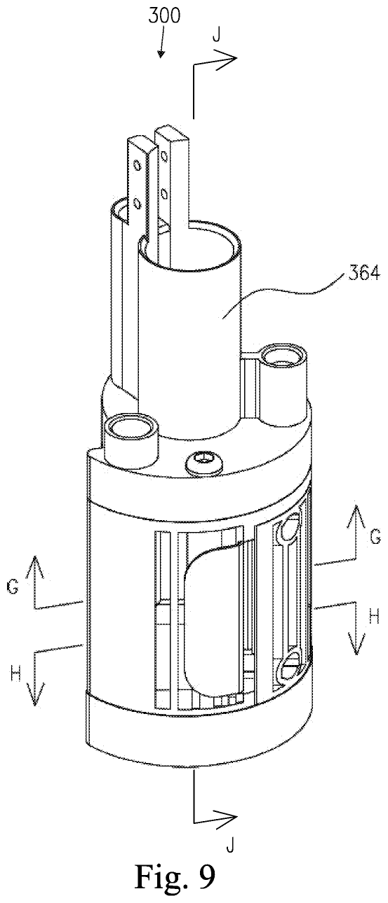

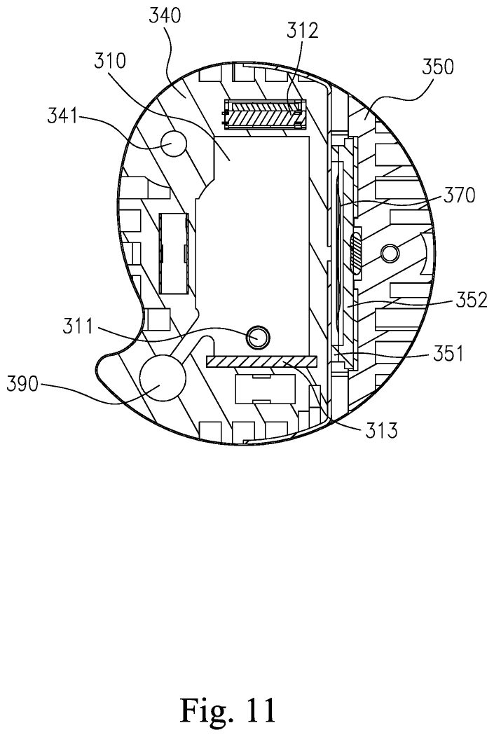

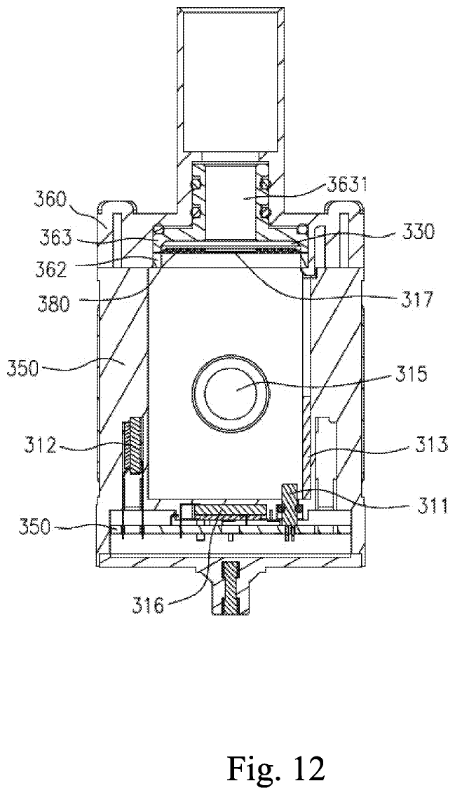

With reference to FIGS. 2 to 13, in some embodiments, the ultrasonic probe 300 has a body 340, a side cover 350, and a top cover 360, with the sensing chamber 310 formed in the body 340. The elastic sidewall of the sensing chamber 310 has a first elastic diaphragm 370 arranged between the body 340 and side cover 350, and the first gas chamber 320 is defined between the first elastic diaphragm 370 and the side cover 350. The elastic top surface of the sensing chamber 310 has a second elastic diaphragm 380 arranged between the body 340 and top cover 360, and the second gas chamber 330 is defined between the second elastic diaphragm 380 and the top cover 360.

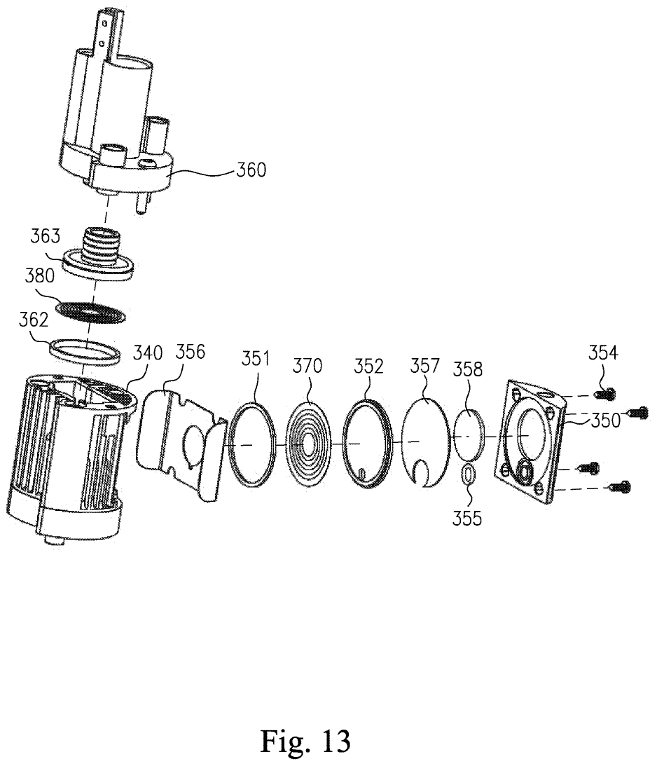

With reference to FIG. 13, in some implementations, the side cover 350 and the top cover 360 are fixed to the body 340 by screws 354.

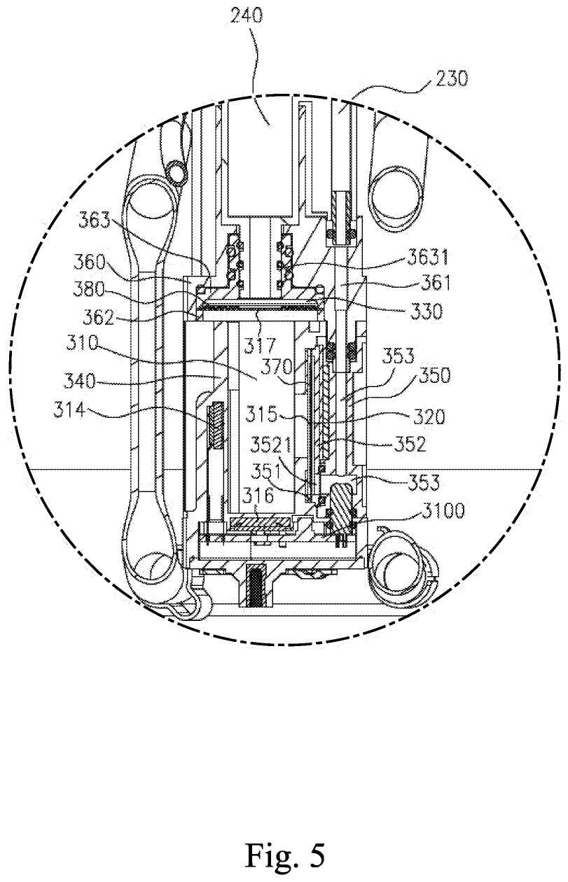

As shown in FIGS. 5, 10, and 11, in some embodiments, a sidewall clamp ring 351 and a sidewall retainer cup 352 are provided between the body 340 and side cover 350 to clamp and fix an outer edge of the first diaphragm 370. The sidewall retainer cup 352 has a sidewall vent hole 3521; the side cover 350 has a sidewall gas passage 353 whose lateral port faces the sidewall vent hole 3521; the top cover 360 has an in-tank gas communication passage 361. The sidewall vent hole 3521, the sidewall passage 353, and the in-tank gas communication passage 361 intercommunicate, and the in-tank gas communication in-tank gas communication passage 361 is in communication with the gas within the liquid storage container via a pipeline. In some implementations, sealing rings 355 are provided to achieve gas-line sealing.

As shown in FIG. 13, in some embodiments, an installation liner 356 and first/second mounting gaskets 357/358 are further provided between the body 340 and the side cover 350.

As shown in FIGS. 5, 8, and 12, in some embodiments, a top-surface clamp ring 362 and a top-surface retainer cup 363 are provided between the body 340 and top cover 360 to clamp and fix an outer edge of the second diaphragm 380. The top-surface retainer cup 363 has a top-surface vent hole 3631, and the top cover 360 has a top-surface gas passage 364. The top-surface vent hole 3631 is in communication with the top-surface gas passage 364, and the top-surface gas passage 364 is in communication with ambient atmosphere outside the liquid storage container via a pipeline.

As shown in FIGS. 1 to 13, in some embodiments, the first ultrasonic reflection module 313 the second ultrasonic reflection module 315, and the third ultrasonic reflection module 317 each include a stainless-steel reflector whose reflective face is exposed to the liquid.

In some implementations, the stainless-steel reflector of the first ultrasonic reflection module 313 is embedded in the first rigid sidewall.

As shown in FIGS. 5, 8, 10, and 13, in some embodiments, an outer periphery of the first elastic diaphragm 370 is formed as a bellows, and the stainless-steel reflector of the first ultrasonic reflection module 313 is arranged at a center of the first elastic diaphragm 370. An outer periphery of the second elastic diaphragm 380 is formed as a bellows, and the stainless-steel reflector of the second ultrasonic reflection module 315 is arranged at a center of the second elastic diaphragm 380.

In some implementations, the stainless-steel reflector of the first ultrasonic reflection module 313 is welded to the first elastic diaphragm 370, and the stainless-steel reflector of the second ultrasonic reflection module 315 is welded to the second elastic diaphragm 380.

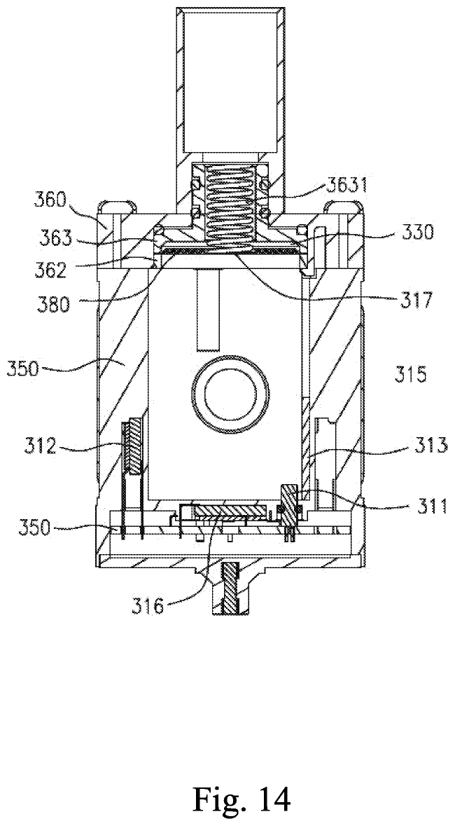

As shown in FIG. 14, in some embodiments, a spring 3631 is provided in the top-surface retainer cup 363, and the spring 3631 is abutted against a back of the second diaphragm 380 to offset part of the load and prevent damage.

In some embodiments, the reservoir channel 390 passes through the ultrasonic probe 300, with an inlet orifice 391 at the bottom of the ultrasonic probe 300 and an outlet orifice 392 at the top of the ultrasonic probe 300.

In some embodiments, an electrical unit 3100 is arranged at the bottom of the ultrasonic probe 300 and is correspondingly and electrically connected to the temperature sensor 311, the first ultrasonic sensing module 312, the second ultrasonic sensing module 314, and the third ultrasonic sensing module 316. A first wire-harness passage 341 is provided on a side of the body 340, and a wire-harness second passage 365 is provided on the top cover 360. A wire harness of the electrical unit 3100 passes through the first wire-harness passage 341 and the wire-harness second passage 365, and is led outside the liquid storage container through a conduit.

In some implementations, the electrical unit 3100 includes a control unit based on a time-of-flight (ToF) chip (e.g., MS1022 or MS1030) to drive the piezoelectric elements in the first ultrasonic sensing module 312, the second ultrasonic sensing module 314, and the third ultrasonic sensing module 316 and time the received reflections, thereby acquiring, recording, and storing TOF values. In some implementations, the electrical unit 3100 further includes a power-supply unit for the ultrasonic probe 300. In some implementations, the electrical unit 3100 further includes a communication unit for interfacing with an upper-level control module.

Referring to FIG. 1, the pneumatically driven liquid metering injection apparatus provided by the present application includes a gas source 100, a storage tank 200, the ultrasonic probe 300, and a control module 400.

The gas source 100 provides driving airflow for liquid migration and injection and can be independent arranged or be the vehicle's gas source.

The storage tank 200 accommodates a liquid to be injected and the ultrasonic probe 300; it connects to the gas source 100 via an intake pipeline 210 to receive airflow from the gas source 100 and discharge the accommodated liquid via an outlet pipeline 220. In some implementations, a urea solution is injected into the exhaust via an injection valve 500. In some implementations, the intake pipeline 210 includes an air filter 213, and the outlet pipeline 220 includes a liquid filter 221.

The ultrasonic probe 300 measures liquid temperature, concentration, level height, and tank gas pressure.

The control module 400 controls gas supply from the gas source 100 to the storage tank 200 and controls injection from the storage tank 200.

As shown in FIGS. 2 to 7, in some embodiments, the storage tank 200 has a tank body 250 and an end cap 260 that are sealed together. An in-tank gas communication pipeline 230 communicates with the first gas chamber 320 of the ultrasonic probe 300, and an ambient-air communication pipeline 240 communicates with the second gas chamber 330 of the ultrasonic probe 300. The intake pipeline 210, the outlet pipeline 220, and the ambient-air communication pipeline 240 all penetrate the end cap 260. The tank body 250 is hollow with sufficient volume and strength to store the liquid and withstand pneumatic pressure.

In some implementations, the tank body 250 of the storage tank 200 can be formed by drawing/rolling stainless steel (e.g., 304 or 316) and welding, or by molding high-strength engineering plastics reinforced with fibers by multiple insert-molding operations.

In some implementations, an upper end of the tank body 250 is defined as a tank opening of the storage tank 250. The tank opening is welded or formed by outward flanging and drawing. A sealing ring is arranged between the tank opening and the end cap 260 and the tank opening and the end cap 260 are tightened by screws to compress the sealing ring to achieve tightness. The end cap 260 can be metal-machined or molded from high-strength engineering plastic.

In some implementations, Fittings corresponding to the pipelines penetrating the end cap 260 are fixed by welding, threads, inserts, or integral molding.

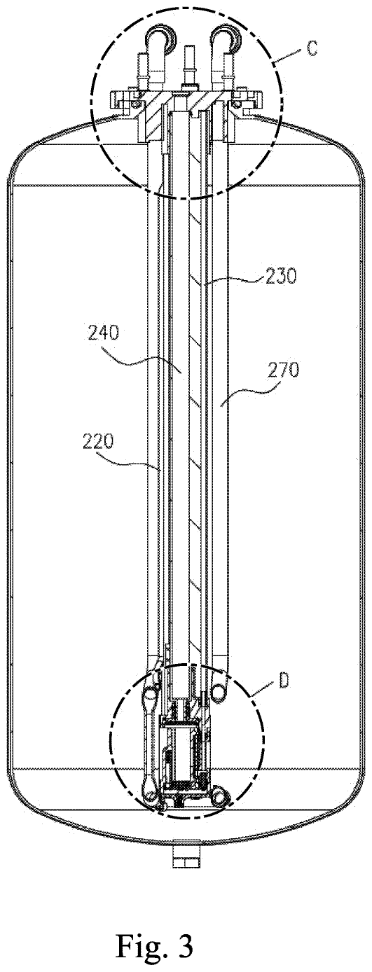

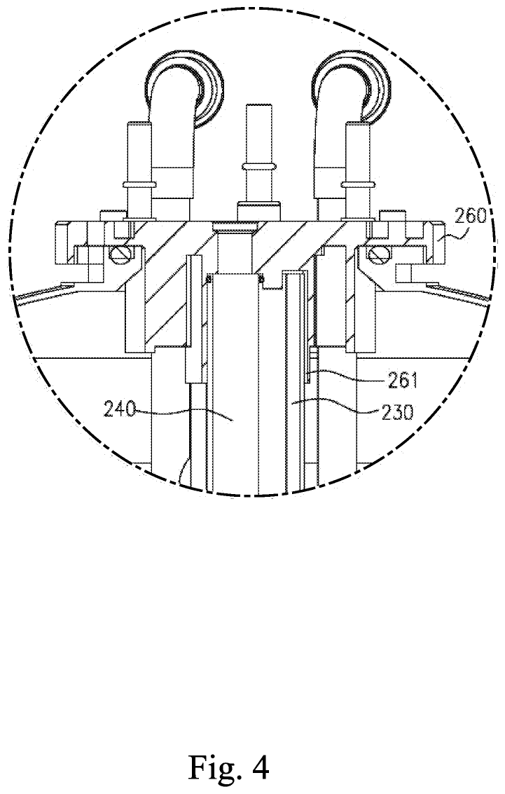

As shown in FIGS. 3 and 4, in some embodiments, a top end of the in-tank gas communication pipeline 230 is fixed to an inner side of the end cap 260, at which an airflow channel 261 is provided; the in-tank gas communication pipeline 230 communicates with the gas within the storage tank 200 via the airflow channel 261.

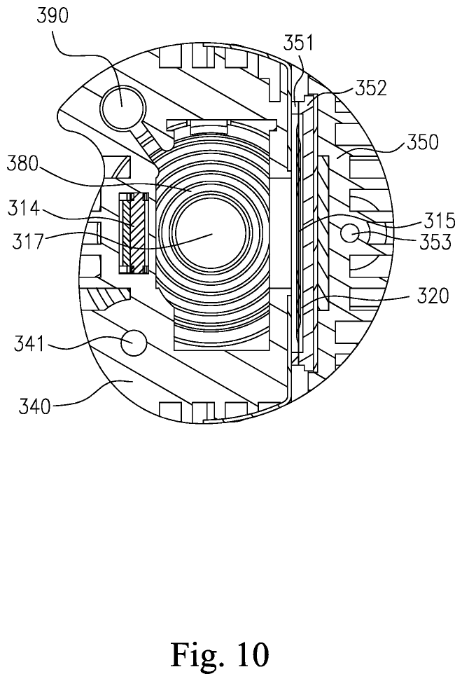

As shown in FIGS. 2 and 10, in some embodiments, a bottom terminal end of the outlet pipeline 220 is plug-fitted into the reservoir channel 390 of the ultrasonic probe 300.

As shown in FIGS. 2 to 8, in some embodiments, the storage tank 200 further includes an antifreeze pipeline 270, and the antifreeze pipeline 270 penetrates the end cap 260. By circulating heated liquid through the antifreeze pipeline 270, freezing of the injection liquid in cold environments can be prevented.

In some implementations, the antifreeze pipeline 270 has an antifreeze fitting 271 formed at the end cap 260 and fixed by a localized bead-locking mechanism.

As shown in FIG. 2, in some embodiments, the tank 200 has a fill port 2100 for charging the liquid into the storage tank 200.

As shown in FIG. 1, in some embodiments, the intake pipeline 210 includes an intake valve 211; the storage tank 200 also has an exhaust pipeline 290 with a vent valve 291. The control module 400 controls the opening/closing of the intake valve 211 and the vent valve 291 together with the gas source 100 to regulate the pressure within the storage tank 200 during injection (e.g., 700 kPa±100 kPa) to provide atomization pressure for metering injection.

As shown in FIG. 1, in some embodiments, the intake pipeline 210 is connected to the outlet pipeline 220 via a purge pipeline 212, and the purge pipeline 212 is provided with a purge valve 2121. the control module 400 is connected to and controls the purge valve 2121 to purge residual liquid from the outlet pipeline 220 and prevent blockage.

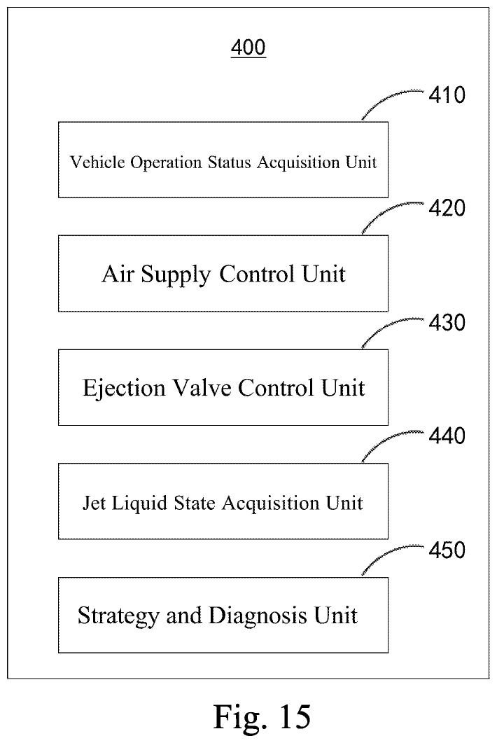

As shown in FIGS. 1 and 15, in some embodiments, the control module 400 includes a vehicle operating-state acquisition unit 410, a gas-supply control unit 420, an injection-valve control unit 430, an injected-liquid state acquisition unit 440, and a strategy and diagnosis unit 450. Power and communication units are also included in the control module 400 for power delivery and data I/O. The module 400 can be deployed in a vehicle DCU (distributed control unit).

The vehicle operating-state acquisition unit 410 acquires the vehicle operating state (driving, idling, and parking). Different states require different injection strategies, and the ultrasonic probe 300 may be affected by different disturbances. In addition, exhaust-control states such as power-up, pressurization, pressure-hold, injection, and depressurization may also be superposed during operation.

The gas-supply control unit 420 controls gas supply from the gas source 100 to the storage tank 200. By operating the intake valve 211, the vent valve 291, and the gas source 100, the supply and the pressure of the gas within the storage tank 200 can be controlled.

The injection-valve control unit 430 sends commands for the injection valve 500 according to the operating state of the vehicle. In some implementations, a representative strategy is Y (f, pwm), where f is injection frequency and pwm is duty cycle, with respective strategies Yxs (fx, pwmx), Yds (fd, pwmd), and Yjc (fj, pwmj) for driving, idling, and parking.

The injected-liquid state acquisition unit 440 acquires temperature, first/second/third TOFs detected by the ultrasonic probe and, using prior calibration data, computes temperature, concentration, level height, and tank gas pressure of the injected liquid by lookup or curve fitting.

The strategy and diagnosis unit 450 sends gas-supply and injection-valve commands according to the operating state of the vehicle, determines the operating state of the pneumatically driven liquid metering injection apparatus from real-time probe data, identifies abnormal conditions including valve clogging/leakage, and adjusts commands for the gas supply and the injection valve to improve NOx management.

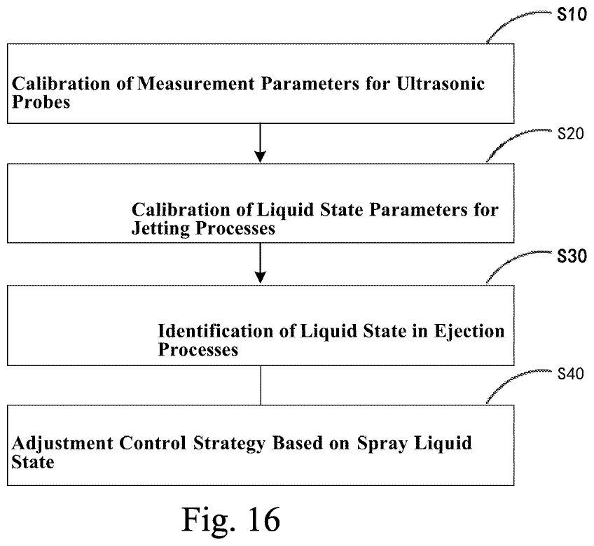

Referring to FIG. 16, a control and fault-diagnosis method for pneumatically driven liquid metering injection based on ultrasonic sensing provided by the present application can be implemented using the above pneumatically driven liquid metering injection apparatus and includes steps S10 to S40:

S10 (calibration of probe measurement parameters): under different liquid temperatures, concentrations, level heights, and tank pressures, obtaining liquid temperature and first/second/third TOFs detected by the ultrasonic probe and calibrating liquid concentration, level height, and tank pressure values.

S20 (calibration of injected-liquid state parameters): under various vehicle operating states, controlling the injection valve and obtain, for no-clogging/no-leakage and for different degrees of clogging or leakage, the rate of change of level height and statistical values related to third-TOF fluctuations; establishing correspondences between clogging/leakage states and said rate/statistical values.

In some implementations, a liquid-path parameter S represents clogging or leakage, and is related to effective orifice area. Given that S₀ is an orifice area when neither clogged nor leaking; S may take values such as 0, 10%·S₀, 20%·S₀, . . . , 100%·S₀, 150%·S₀, 200%·S₀, etc. according to the clogged nor leaking state of the injection valve.

For each engine condition, a maximum urea injection quantity Qs is determined by S and the tank gas pressure P. By dynamically sampling the level height with digital filtering to suppress vehicle-induced noise, the rate of change dH/Dt of level height H reflects the liquid injection rate and correlates with S.

Statistical values related to third TOF fluctuations (e.g., mean, variance, standard deviation, amplitude) reflect the fluctuation of tank pressure P. These fluctuations of the tank pressure P can indicate blockage or leakage in the backflow valve. For instance, if the fluctuation of the tank pressure P decreases while the injection control strategy remains unchanged, it suggests blockage in the injection valve, resulting in a reduction of the liquid passage parameter S.

S30 (injected-liquid state identification): during operation, acquiring the vehicle operating state; obtaining the data of liquid temperature and the first/second/third TOFs through the ultrasonic probe; compute the rate of change of level height and the third-TOF fluctuation statistics; identifying clogging or leakage of the injection valve.

S40 (strategy adjustment based on the injected-liquid state): adjusting the current injection-valve control strategy according to the vehicle operating state and the identified clogging or leakage to improve NOx management. For example, upon partial clogging, increase valve open time or duty cycle.

The ultrasonic probe of the present application achieves high-precision measurement of liquid temperature, concentration, level height, and tank pressure with high integration and low cost; the apparatus is compact by placing the probe inside the tank and integrating urea injection control with state monitoring; the method adjusts the injection strategy based on real-time monitoring to improve NOx management.

The above embodiments are merely used to illustrate the technical solution of the present application and not to limit them. Other modifications or equivalent substitutions made by those skilled in the art without departing from the spirit and scope of the claims are within the protection scope.

What is claimed is:

1. An ultrasonic probe disposed inside a liquid storage container and configured to measure liquid temperature, concentration, liquid-level height, and storage gas pressure, the ultrasonic probe comprising:
a sensing chamber configured to receive a liquid under test;
a reservoir channel in communication with the sensing chamber and an internal accommodation space of the liquid storage container;
a temperature sensor disposed within the sensing chamber and configured to measure the liquid temperature;
a first ultrasonic reflection module disposed on a first rigid sidewall of the sensing chamber;
a first ultrasonic sensing module disposed on a second rigid sidewall of the sensing chamber and configured to transmit an ultrasonic detection signal to the first ultrasonic reflection module, receive a reflected signal, and obtain a first ultrasonic time-of-flight (TOF) indicative of the liquid concentration;
a second ultrasonic reflection module disposed on an elastic sidewall of the sensing chamber, a first gas chamber being provided outside the elastic sidewall, the first gas chamber being in communication with gas in the liquid storage container, and the elastic sidewall being configured to deform according to a difference between a liquid pressure at its position within the sensing chamber and a gas pressure within the liquid storage container;
a second ultrasonic sensing module disposed on a third rigid sidewall of the sensing chamber and configured to transmit an ultrasonic detection signal to the second ultrasonic reflection module, receive a reflected signal, and obtain a second ultrasonic TOF indicative of the liquid-level height;
a third ultrasonic reflection module disposed on an elastic top surface of the sensing chamber, a second gas chamber being provided above the elastic top surface, the second gas chamber being in communication with ambient atmosphere outside the liquid storage container, and the elastic top surface being configured to deform according to a difference between a liquid pressure at its position within the sensing chamber and ambient atmospheric pressure; and
a third ultrasonic sensing module disposed on a bottom surface of the sensing chamber and configured to transmit an ultrasonic detection signal to the third ultrasonic reflection module, receive a reflected signal, and obtain a third ultrasonic TOF indicative of an internal gas pressure of the liquid storage container.

2. The ultrasonic probe according to claim 1, further comprising a body, a side cover, and a top cover, the sensing chamber being arranged in the body; the elastic sidewall of the sensing chamber having a first elastic diaphragm arranged between the body and the side cover, the first gas chamber being defined between the first elastic diaphragm and the side cover; and the elastic top surface of the sensing chamber having a second elastic diaphragm arranged between the body and the top cover, the second gas chamber being defined between the second elastic diaphragm and the top cover.

3. The ultrasonic probe according to claim 2, wherein a sidewall clamp ring and a sidewall retainer cup are provided between the body and the side cover to clamp and fix an outer edge of the first elastic diaphragm; the sidewall retainer cup is provided with a sidewall vent hole, the side cover is provided with a sidewall gas passage, and a lateral port of the sidewall gas passage faces the sidewall vent hole; the top cover is provided with an in-tank gas communication passage; the sidewall vent hole, the sidewall gas passage, and the in-tank gas communication passage are correspondingly in mutual communication, and the in-tank gas communication passage is in communication with gas within the liquid storage container via a pipeline.

4. The ultrasonic probe according to claim 2, wherein a top-surface clamp ring and a top-surface retainer cup are provided between the body and the top cover to clamp and fix an outer edge of the second elastic diaphragm; the top-surface retainer cup is provided with a top-surface vent hole, the top cover is provided with a top-surface gas passage, the top-surface vent hole is in communication with the top-surface gas passage, and the top-surface gas passage is in communication with ambient atmosphere outside the liquid storage container via a pipeline.

5. The ultrasonic probe according to claim 1, wherein each of the first ultrasonic reflection module, the second ultrasonic reflection module, and the third ultrasonic reflection module is made of stainless steel and is provided with a planar reflective surface.

6. The ultrasonic probe according to claim 2, wherein an outer periphery of the first elastic diaphragm is formed as a bellows, and the first ultrasonic reflection module is disposed at a center of the first elastic diaphragm; an outer periphery of the second elastic diaphragm is formed as a bellows, and the second ultrasonic reflection module is disposed at a center of the second elastic diaphragm.

7. The ultrasonic probe according to claim 6, wherein the first ultrasonic reflection module is welded to the first elastic diaphragm, and the second ultrasonic reflection module is welded to the second elastic diaphragm.

8. The ultrasonic probe according to claim 4, wherein a spring is provided within the top-surface retainer cup, and the spring is abutted against a back side of the second elastic diaphragm.

9. The ultrasonic probe according to claim 1, wherein the reservoir channel passes through the ultrasonic probe, an inlet orifice is provided at a bottom of the ultrasonic probe, and an outlet orifice is provided at a top of the ultrasonic probe.

10. The ultrasonic probe according to claim 2, wherein an electrical unit is provided at a bottom of the ultrasonic probe, the electrical unit is correspondingly and electrically connected to the temperature sensor, the first ultrasonic sensing module, the second ultrasonic sensing module, and the third ultrasonic sensing module; the body is provided with a first wire-harness passage, and the top cover is provided with a second wire-harness passage; a wire harness of the electrical unit passes through the first and second wire-harness passages and is led out of the liquid storage container via a conduit.

11. A pneumatically driven liquid metering injection apparatus, comprising:
the ultrasonic probe according to claim 1;
a gas source configured to provide a driving airflow for injection of a liquid;
a storage tank configured to accommodate a liquid to be injected and the ultrasonic probe, the storage tank being connected to the gas source via an intake pipeline to receive airflow from the gas source and being configured to discharge the accommodated liquid to an exterior via an outlet pipeline; and
a control module configured to control supply of gas from the gas source to the storage tank and to control injection of the liquid from the storage tank.

12. The pneumatically driven liquid metering injection apparatus according to claim 11, wherein the storage tank is provided with a tank body and an end cap, the tank body and the end cap are sealed together; an in-tank gas communication pipeline in communication with the first gas chamber of the ultrasonic probe is provided within the storage tank; an ambient-air communication pipeline in communication with the second gas chamber of the ultrasonic probe is provided within the storage tank; and the intake pipeline, the outlet pipeline, and the ambient-air communication pipeline all penetrate the end cap.

13. The pneumatically driven liquid metering injection apparatus according to claim 12, wherein a top end of the in-tank gas communication pipeline is fixed to an inner side of the end cap, the inner side of the end cap is provided with an airflow channel, and the in-tank gas communication pipeline is in communication with gas inside the storage tank via the airflow channel.

14. The pneumatically driven liquid metering injection apparatus according to claim 12, wherein a bottom terminal end of the outlet pipeline is plug-fitted into the reservoir channel of the ultrasonic probe.

15. The pneumatically driven liquid metering injection apparatus according to claim 12, wherein an antifreeze pipeline is further provided within the storage tank, and the antifreeze pipeline penetrates the end cap.

16. The pneumatically driven liquid metering injection apparatus according to claim 11, wherein the storage tank is provided with a fill port.

17. The pneumatically driven liquid metering injection apparatus according to claim 11, wherein the intake pipeline is provided with an intake valve; the storage tank is further provided with an exhaust pipeline, the exhaust pipeline is provided with a vent valve; and the control module is connected to and controls the intake valve and the vent valve.

18. The pneumatically driven liquid metering injection apparatus according to claim 11, wherein the intake pipeline is further connected to the outlet pipeline via a purge pipeline, the purge pipeline is provided with a purge valve; and the control module is connected to and controls the purge valve.

19. The pneumatically driven liquid metering injection apparatus according to claim 11, wherein the control module includes:
a vehicle operating-state acquisition unit configured to acquire a vehicle operating state;
a gas-supply control unit configured to control supply of gas from the gas source to the storage tank;
an injection-valve control unit configured to send control commands to an injection valve based on the vehicle operating state;
an injected-liquid state acquisition unit configured to acquire the temperature, the first ultrasonic TOF, the second ultrasonic TOF, and the third ultrasonic TOF detected by the ultrasonic probe, and, based on prior calibration data, determine the temperature, the concentration, the liquid-level height, and the storage gas pressure of the injected liquid by lookup or curve-fitting calculation; and
a strategy and diagnosis unit configured to, based on the vehicle operating state, send control commands to a gas supply and the injection valve, determine an operating state of the pneumatically driven liquid metering injection apparatus based on real-time detection data of the ultrasonic probe, identify abnormal operating conditions, and adjust the control commands for the gas supply and the injection valve to obtain improved NOx management.

20. A control and fault-diagnosis method for pneumatically driven liquid metering injection based on ultrasonic sensing, comprising:
calibrating ultrasonic-probe measurement parameters: under different conditions of liquid temperature, concentration, liquid-level height, and storage gas pressure, obtaining data of liquid temperature, first ultrasonic TOF, second ultrasonic TOF, and third ultrasonic TOF detected by an ultrasonic probe, and calibrating values of liquid concentration, liquid-level height, and storage gas pressure;
calibrating injected-liquid state parameters: controlling injection by an injection valve under respective vehicle operating states to obtain, for the injection valve under no-clogging and no-leakage conditions and under different degrees of clogging or leakage, a rate of change of the liquid-level height and statistical values related to fluctuations of the third ultrasonic TOF, and establishing correspondences between the clogging and leakage states of the injection valve and the rate of change of the liquid-level height and the statistical values related to fluctuations of the third ultrasonic TOF;
identifying an injected-liquid state: acquiring the vehicle operating state, acquiring the data of liquid temperature, first ultrasonic TOF, second ultrasonic TOF, and third ultrasonic TOF via the ultrasonic probe, calculating the rate of change of the liquid-level height and the statistical values related to fluctuations of the third ultrasonic TOF, and identifying a clogging or leakage state of the injection valve; and
adjusting a control strategy based on the injected-liquid state: adjusting a current injection-valve control strategy according to the vehicle operating state and the identified clogging or leakage state of the injection valve to obtain improved NOx management.
